(19) United States
(12) Patent Application Publication
(10) Pub. No.: US 2025/0038179 A1
(43) Pub. Date: Jan. 30, 2025

(54) COMPOSITE MATERIAL AND METHOD FOR PRODUCING COMPOSITE MATERIAL

(71) Applicant: Tec One Co., Ltd., Nomi-shi (JP)

(72) Inventor: Takahiro KITANO, Nomi-shi (JP)

(73) Assignee: Tec One Co., Ltd., Nomi-shi (JP)

(21) Appl. No.: 18/557,169

(22) PCT Filed: Aug. 15, 2022
(86) PCT No.: PCT/JP2022/030910

§ 371 Date: Oct. 25, 2023

(51) Int. Cl. H01M 4/36; H01M 4/02; H01M 4/38; H01M 4/48

(52) U.S. Cl. CPC H01M 4/366; H01M 4/387; H01M 4/483; H01M 2004/021

(57) ABSTRACT

A composite material used as a negative electrode material, the composite material being easy handleable, having a high discharge capacity, a high cycle characteristic, and a high initial efficiency. The composite material has a resin-made thermolysis product, SiOx (x≤1.2), and Sn. In the composite material, a surface of the SiOx particle is coated by the resin-made thermolysis product, and the Sn particles exist in the SiOx particle. The composite material has substantially no Li.

### TECHNICAL FIELD

The present invention relates to a composite material, for example, suitable for a negative electrode material used in a lithium-ion battery.

### BACKGROUND ART

As the negative electrode material used in the lithium-ion battery, a Si—Sn composite material containing SiO (silicon monoxide) and Sn is proposed.

For example, WO2006/78269 (i.e., JP2007-535459A which is listed here as Patent Literature 1) discloses a silicon and/or tin containing chemical compound nanodispersed in a lithium containing skeleton.

JP2014-107013A (Patent Literature 2) discloses a composite material in which powder selected from the group consisting of carbon powder, silicon metal powder, silicon alloy powder, SiOx (0<x<2) powder, and Sn powder is dispersed in a matrix of a chemical compound expressed by a composition formula of LiaSiOb (in the formula, 0<a<4; 0<b<4) having a Li—O—Si bond.

All the above-mentioned inventions are made on the premise that Li is an essential element. The composite material containing Li, however, is unstable both in the air and in the water. From this point of view, a Li-free material is desired as the negative electrode material used in the lithium-ion battery.

As the Li-free material to be used as the negative electrode material used in the lithium-ion battery, the following proposals are made.

JP2003-192327A (Patent Literature 3) discloses a method for producing metallic element dope silicon oxide power. The method includes processes of: generating a SiOx gas by heating mixed row material powder containing SiO₂ powder at a temperature of 1100-1600° C. in the presence (or under reduced pressure) of an inert gas; generating a metal vapor gas by heating a metal other than Si (e.g., Al, B, Ca, K, Na, Li, Ge, Mg, Co, and Sn) or a metal compound, or a mixture thereof; and depositing a mixed gas of the SiOx gas and the metal vapor gas onto a surface of a base material which is cooled to a temperature of 100-500° C. In a lithium-ion secondary battery with the negative electrode made of the metallic element dope silicon oxide powder according to Example 1 of this disclosure, an initial charge capacity is 920 mAh/g; an initial discharge capacity is 850 mAh/g; an initial charge discharge efficiency is 92.4%; a discharge capacity at the time of 10^{th} cycle is 780 mAh/g; and a retention rate of a capacity after 10 cycles is 91.7%. In a lithium-ion secondary battery with the negative electrode made of metallic element dope silicon oxide powder according to Example 2, the initial charge capacity is 780 mAh/g; the initial discharge capacity is 750 mAh/g; the initial charge discharge efficiency is 96.2%; the discharge capacity at the time of 10^{th} cycle is 730 mAh/g; and the retention rate of the capacity after 10 cycles is 97.3%. The retention of cyclability is high while the initial charge capacity is small. That is, Patent Literature 3 is not technically satisfactory.

WO2014/95811 (i.e., JP2016-507859A which is listed here as Patent Literature 4) discloses an active material for a rechargeable lithium ion battery made by containing metal (M:Si) based particles and SiOx (0<x<2), in which the SiOx is an intimate mixture of a non-crystalline silicon (Si) and a crystalline silicon dioxide (SiO₂). In Patent Literature 4, instead of Si (M), Sn, Sb, Ni, Ti, In, Al, and Fe are proposed. In Examples of Patent Literature 4, however, only a case where the M is Si is disclosed. In Claim 10 thereof, the M is restricted to Si. Patent Literature 4 fails to disclose that equivalent physical property could be obtained when Sn, Sb, Ni, Ti, In, Al, and Fe are used instead of Si. In a lithium-ion secondary battery with the negative electrode made of an active material according to the Examples of Patent Literature 4, the initial charge capacity is 2050-2350 mAh/g; the initial discharge capacity is 1165-1724 mAh/g; the discharge capacity after 50 cycles is 417-650 mAh/g; and a retention rate of the capacity after 50 cycles is 24-56%. The initial charge capacity is large while the retention rate of the capacity after 50 cycles is low. That is, Patent Literature 4 is not technically satisfactory.

### CITATION LIST

### Patent Literature

### [Patent Literature 1]

WO2006/78269

### [Patent Literature 2]

JP2014-107013A

### [Patent Literature 3]

JP2003-192327A

### [Patent Literature 4]

WO2014/95811

### Non-Patent Literature

### [Non-Patent Literature 1]

Electrochemistry, 90 (2022)

### SUMMARY OF INVENTION

### Technical Problem

The present invention is made to solve the above listed problems.

For example, the present invention is made to provide a negative electrode material of the large discharge capacity (the initial discharge capacity, for example, of 1500 mAh/g or greater) and the high cycle characteristic (the capacitance maintenance factor after 500 cycles, for example, of 80% or higher).

The present invention is made to provide the negative electrode material of the high initial charge discharge efficiency (e.g., 75% or higher).

The present invention is made to provide the negative electrode material which is stable both in the air and in the water and easy to handle.

### Solution to Problem

The present invention is directed to a composite material:
wherein the composite material has a resin-made thermolysis product, a SiOx (x≤1.2), and Sn;
wherein a surface of the SiOx particle is coated by the resin-made thermolysis product;
wherein the Sn particles exist in the SiOx particle; and
wherein the composite material has substantially no Li.

The present invention is directed to the composite material, wherein, preferably, one or more oxide selected from the group consisting of an aluminum oxide and a magnesium oxide exists between the resin-made thermolysis product and the SiOx (x≤1.2).

The present invention is directed to the composite material, wherein, preferably, the resin has a polar group.

The present invention is directed to the composite material, wherein, preferably, the resin is a thermoplastic resin.

The present invention is directed to the composite material, wherein, preferably, the resin is a polyvinyl alcohol.

The present invention is directed to the composite material, wherein, preferably, the Sn particles each is smaller in size than the SiOx (x≤1.2) particle.

The present invention is directed to the composite material, wherein, preferably, the SiOx particle has an average diameter of 1-20 μm.

The present invention is directed to the composite material, wherein, preferably, the Sn particles have an average diameter of 1-50 nm.

The present invention is directed to the composite material, wherein, preferably, the resin-made thermolysis product is 5-20 pts·mass to the SiOx of 100 pts·mass, and the Sn particle is 1-10 pts·mass to the SiOx of 100 pts·mass.

The present invention is directed to the composite material, wherein, preferably, one or more oxide selected from the group consisting of the aluminum oxide and the magnesium oxide, to the SiOx of 100 pts·mass, is 2-20 pts·mass when it is converted to a numerical value of the corresponding Al or Mg.

The present invention is directed to the composite material, wherein, preferably, SiOy (0≤y<1, y<x) exists in a layer of the oxide.

The present invention is directed to the composite material, wherein, preferably, the oxide layer has a thickness of 10-1000 nm.

The present invention is directed to a negative electrode made by using the composite material.

The present invention is directed to a secondary battery with the negative electrode.

The present invention is directed to a method for producing composite material:
wherein a surface of the SiOx (x≤1.2) particle is resin-coated;
wherein the resin-coated SiOx (x≤1.2) particle is mixed with Sn particles; and
wherein the mixture is heated.

The present invention is directed to the method for producing composite material, wherein, preferably, upon the mixture, one or more selected from the group consisting of Al particles and Mg particles is further mixed.

The present invention is directed to the method for producing composite material, wherein, preferably, the resin has a polar group.

The present invention is directed to the method for producing composite material, wherein, preferably, the resin is a thermoplastic resin.

The present invention is directed to the method for producing composite material, wherein, preferably, the resin is a polyvinyl alcohol.

The present invention is directed to the method for producing composite material, wherein, preferably, the Sn particles each is smaller in size than the SiOx (x≤1.2) particle.

The present invention is directed to the method for producing composite material:
wherein, preferably, the composite material obtainable from the producing method has a resin-made thermolysis product, SiOx (x≤1.2), and Sn;
wherein the surface of the SiOx particle is coated by the resin-made thermolysis product;
wherein the Sn particles exist in the SiOx particle; and
wherein the composite material has substantially no Li.

The present invention is directed to the method for producing composite material:
wherein, preferably, the composite material obtainable from the producing method has a resin-made thermolysis product, SiOx (x≤1.2), Sn, and an oxide (one or more oxide selected from the group consisting of an aluminum oxide and a magnesium oxide);
wherein the surface of the SiOx particle is coated by the resin-made thermolysis product;
wherein the Sn particles exist in the SiOx particle;
wherein the oxide exists between the resin-made thermolysis product and the SiOx (x≤1.2); and
wherein the composite material has substantially no Li.

### Advantageous Effect of Invention

A lithium ion battery with a negative electrode made by using the composite material of the present invention was excellent.

The discharge capacity was large. For example, the initial discharge capacity was 1500 mAh/g or greater.

The cycle characteristic was high. For example, the capacitance maintenance factor after 500 cycles was 80% or higher.

The initial charge discharge efficiency was high. For example, it was 75% or higher.

It was stable in the air and, also, in the water. It was easy to handle.

### BRIEF DESCRIPTION OF DRAWINGS

FIG. 1 is a schematic diagram illustrating a composite material of the present invention.

FIG. 2 is another schematic diagram illustrating the composite material of the present invention.

FIG. 3 is a further schematic diagram illustrating the composite material of the present invention.

FIG. 4 is further another schematic diagram illustrating the composite material of the present invention.

FIG. 5 is a STEM image (annular dark filed image (ADF-STEM, 100,000 times)) of the composite material according to Example 6.

FIG. 6 is another STEM image (annular dark filed image (ADF-STEM, 800,000 times)) of the composite material according to Example 6.

FIG. 7 is a further STEM image (annular dark filed image (SE-STEM)) of the composite material according to Example 6.

FIG. 8 is a EDX mapping image (Sn) of the composite material according to Example 6.

FIG. 9 is another EDX mapping image (Si) of the composite material according to Example 6.

FIG. 10 is a further EDX mapping image (O) of the composite material according to Example 6.

FIG. 11 is further another EDX mapping image (Al) of the composite material according to Example 6.

FIG. 12 is further another EDX mapping image (C) of the composite material according to Example 6.

FIG. 13 is a XRD measurement result of the composite material according to Example 6.

### DESCRIPTION OF EMBODIMENTS

The first invention is directed to a composite material. The composite material has a resin-made thermolysis product. The composite material has SiOx (x≤1.2). The x, preferably, was 1.1 or less. The x, preferably, was 0.8 or greater. The x, preferably, was 0.9 or greater. The SiOx, preferably, was SiO. Basically, the SiOx may be anything so far as it belongs to a range of a silicon monoxide. The SiOx is not SiO₂. The surface of the SiOx particle is coated by the resin-made thermolysis product. The “being coated” is not limited to “being coated completely”. There may be an uncoated part. The composite material has Sn. The Sn particles exist in the SiOx particle. The Sn particles are dispersed in the SiOx particle. The Sn particles are metal particles. The Sn particles are not oxide particles. It is not clear why the capacity and the cycle characteristic improve when the Sn particles (metal particles) are dispersed in the SiOx particle. Here, the inventor assumed that the characteristic improving effect could be produced based on such factors that the Sn reacts with Li+; the Sn particles have conductivity; and the Sn particles are dispersed in the SiOx particle. There is no particular restriction in purity of the Sn. The purity of 99% or higher was preferred. The purity of 99.5% or higher was more preferred. The composite material has substantially no Li. The “having substantially no Li” means “having up to a degree that the existence of Li does not degrades the characteristics of the present invention”.

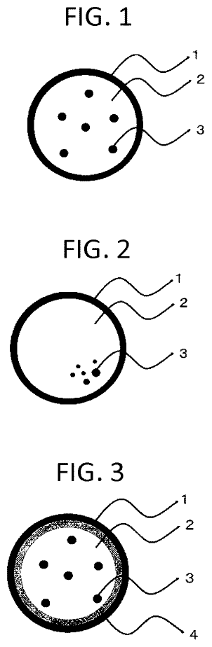

FIGS. 1 and 2 show schematic diagrams of the composite material. In FIGS. 1 and 2, 1 denotes a resin-made thermolysis product. Main component of the resin-made thermolysis product 1 is C. C is contained by 95% or higher. 2 denotes a SiOx particle. 3 denotes a Sn particle (metal particle). In the composite material of FIG. 1, the Sn particles 3 are dispersed uniformly in the SiOx particle 2. In the composite material of FIG. 2, the Sn particles 3 are dispersed unevenly toward the surface layer of the SiOx particle 2. The composite material as shown in FIG. 2 (i.e., the composite material in which the Sn particles are dispersed in a biased manner toward the surface layer) was more excellent than the composite material as shown in FIG. 1. The inventor assumes the reason thereof as follows. Namely, the composite material as shown in FIG. 2 easily reacts with Li+ because the Sn particles incline to the surface layer.

The existence of the Sn particles 3 dispersed in the SiOx particle 2 can be confirmed by an X-ray diffraction (XRD). It can also be confirmed by the observation using both a Scanning Transmission Electron Microscopy (STEM) and an Energy Dispersing Type X-Ray Analysis (EDX). According to the observation method, not only the existence of the Sn particles but also a particle diameter and existing positions of the particles can be confirmed. The XRD cannot detects the Sn particles of a size of an atomic level.

The composite material, preferably, has an oxide (one or more oxide selected from the group consisting of an aluminum oxide and a magnesium oxide). The oxide may have any structure. For example, it may be Al₂O₄, MgO, and Al₂MgO₄. The oxide exists between the resin-made thermolysis product and the SiOx. FIG. 3 shows a schematic diagram of a composite material having the oxide layer. In FIG. 3, 1 denotes a resin-made thermolysis product. 2 denotes a SiOx particle. 3 denotes a Sn particle. 4 denotes an oxide (one or more oxide selected from the group consisting of an aluminum oxide and a magnesium oxide) layer. The oxide layer 4 exists inside a layer of the resin-made thermolysis product 1 and outside of the SiOx particle 2.

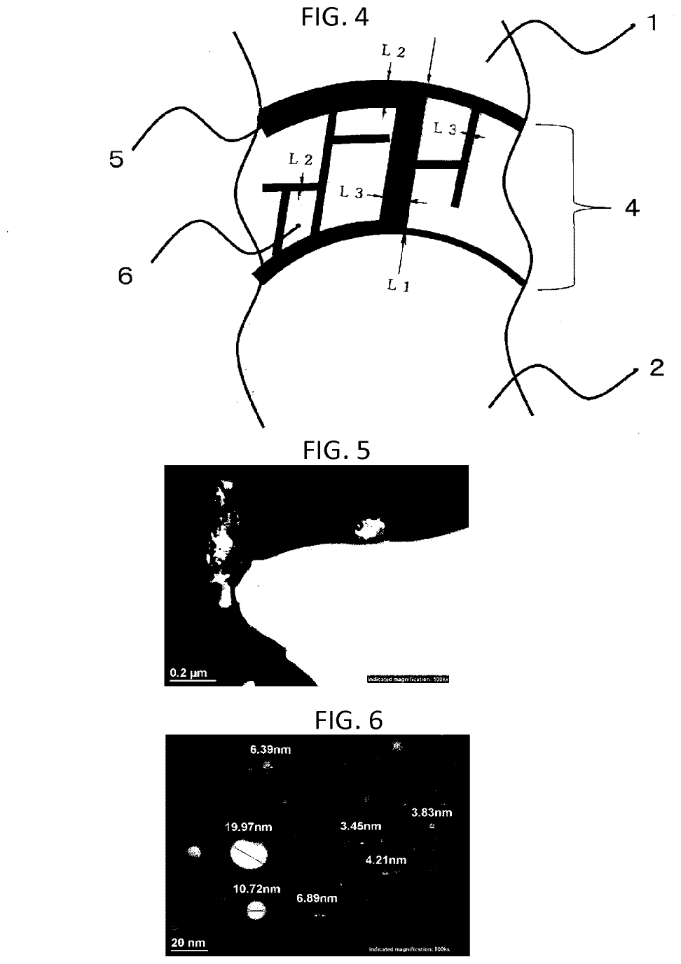

The oxide layer will be described below in detail. Inside the oxide (e.g., Al₂O₃, MgO, and Al₂MgO₄) layer 4, there existed SiOy (0≤y<1, y<x) 6 (see, FIG. 4). In FIG. 4, 1 denotes a resin-made thermolysis product. 2 denotes a SiOx particle. 4 denotes the oxide layer. 5 denotes the oxide region (phase). In the oxide region (phase) 5, the oxide is consecutive (is continuous). 6 denotes a SiOy region (phase) existing in a manner being enclosed by the continuous oxide region (phase) 5. The structure of the oxide layer 4 is often liken to a structure as if there are many islands in the sea. The continuous oxide region (phase) 5 is the sea and the SiOy 6 are islands. Alternatively, the structure of the oxide layer 4 is also liken to a structure that SiOy particles 6 are dispersed in the oxide (e.g., Al₂O₃, MgO, and Al₂MgO₄) layer 4. Further alternatively, the structure of the oxide layer 4 is also liken to a honeycomb structure. Space parts of the honeycomb structure are the SiOy 6. The SiOy 6 is also liken to a structure that the SiOy 6 is enclosed by the oxide (e.g., Al₂O₃, MgO, and Al₂MgO₄) continuous region 5. The oxide layer 4 can also be said to have a two-phase structure composed of the continuous oxide region (phase) 5 and the SiOy region (phase) 6. The SiOy 6 (SiOy: isolated region) is, so called, as an independent phase. The SiOy contains, relatively, more Si (less O) compared to SiO. The reason why not the SiOx but the SiOy contains more Si is because, during a process that Al and Mg become an oxide, O is taken from the SiOx. That is because the SiOx is reduced by Al, Mg. By the SiOy, a large capacity and a high initial effect can be realized. The SiOy tends to react with water. A volume change upon discharge and charge is large in the SiOy. Therefore, if the phase of the SiOy exists in an exposed manner, handling thereof upon producing an electrode was difficult. Cycle characteristic was degraded. Therefore, such a structure that the SiOy region (phase) is enclosed by an oxide (an aluminum oxide or a magnesium oxide) was employed. The oxide does not react with water and Li+. For this reason, it is easy to handle. Degrading of the initial efficiency hardly occurred. A volume change of the SiOy upon discharge and charge was well controlled. The cycle characteristic improved. It was preferable that a surface contacting with the resin-made thermolysis product was a continuous phase of the oxide. Complete coating of the surface of the SiOx particle by the oxide layer containing the SiOy is preferred. But a case where there is an uncoated part in the SiOx particle is not precluded.

The structure of the oxide region can be confirmed by the observation using both a Scanning Transmission Electron Microscopy (STEM) and an Energy Dispersing Type X-Ray Analysis (EDX). The structure of the SiOy can be determined from EDX mapping images of Si and O. If the concentrations of Si and O in the SiOy region is equivalent to the concentration of Si and O in the SiO region, the SiOy is SiO. If the concentration of Si in the SiOy region is higher than the concentration of Si in the SiO region, it can be so determined that the SiOy is SiOy (0≤y<1, y<x).

Preferably, the resin was a resin having a polar group. More preferably, the resin was a thermoplastic resin. Particularly preferably, the resin was polyvinyl alcohol (PVA). The inventor assumed that the reason thereof is as stated below. The thermolysis product made of PVA has conductivity. The thermolysis product made of PVA has high polarity as compared to a graphite, etc. For this reason, upon producing an electrode, the thermolysis product made of PVA was easy to be dispersed in a solvent such as water. Upon producing a lithium ion battery, an electrolytic solution penetrated speedily.

Preferable PVA had a viscosity of 1-300 mPa·s at 20° C. of 4% aqueous solution. More preferable PVA had a viscosity of 2-10 mPa·s. PVA having a saponification degree of 75-90 mol % was preferred. PVA having a saponification degree of 80 mol % or greater was more preferred. The saponification degree was calculated according to JIS K 6726. For example, a specimen of 1-3 pts·wt., water of 100 pts·wt., and 3 drops of phenolphthalein solution were added in proportion to the estimated saponification degree. They dissolved completely. A NaOH aqueous solution of 0.5 mol/L was added by 25 mL, and, after stirring, it was left for 2 hours. A HCl aqueous solution of 0.5 mol/L was added by 25 mL. A titration was performed by using the NaOH aqueous solution of 0.5 mol/L. The saponification degree (H) was calculated by the following formulas (1) to (3).

$$X 1 = \{ ( a - b ) \times f \times D \times 0.06005 \} / \{ S \times ( P / 100 ) \} \times 100 \qquad Formula ( 1 )$$

$$X 2 = ( 44.05 \times X 1 ) / ( 60.05 - 0.42 \times X 1 ) \qquad Formula ( 2 )$$

$$H = 100 - X 2 \qquad Formula ( 3 )$$

X1: acetic acid (%) corresponding to residual acetic acid group
X2: residual acetic acid group (mol %)
H: saponification degree (mol %)
a: used volume (mL) of 0.5 mol/I NaOH solution
b: used volume (mL) of 0.5 mol/l NaOH solution upon blank test
f: factor of 0.5 mol/I NaOH solution
D: concentration of normal solution (0.1 mol/l or 0.5 mol/l)
S: specimen collection quantity (g)
P: fineness (%) of specimen

Preferably, the Sn particles each is smaller in size than the SiOx particle. Preferably, the SiOx particle had an average diameter of 1 μm or greater. More preferably, the average diameter was 3 μm or greater. Further preferably, the average diameter was 4 μm or greater. Preferably, the average diameter was 20 μm or less. More preferably, the average diameter was 10 μm or less. Further preferably, the average diameter was 8 μm or less. Preferably, the Sn particles have an average diameter of 1 nm or greater. More preferably, the average diameter was 2 nm or greater. Further preferably, the average diameter was 3 nm or greater. Preferably, the average diameter was 50 nm or less. More preferably, the average diameter was 30 nm or less. Further preferably, the average diameter was 20 nm or less. In a case where the particle diameter of the Sn particle was too small, effects produced in capacity improvement and cycle characteristic were small. Handling thereof upon mixture was difficult. In a case where the particle diameter was too large, the cycle characteristic was degraded. There was a difficulty in mixture. Variation in the particle diameter of the Sn particle is acceptable. FIG. 1 shows a case where the Sn particles have the same particle diameter. FIG. 2 shows a case where the Sn particles have different particle diameters. Even when there exist the particles having particle diameters outside the above-mentioned range, it is acceptable when many of the particles have a particle diameter within the above-mentioned range.

Preferably, the resin-made thermolysis product was 5 pts·mass or greater to the SiOx of 100 pts·mass. More preferably, it was 7 pts·mass or greater. Further preferably, it was 9 pts·mass or greater. Preferably, it was 20 pts·mass or less. More preferably, it was 18 pts·mass or less. Further preferably, it was 15 pts·mass or less. Preferably, the Sn particles were 1 pts·mass or greater to the SiOx of 100 pts·mass. More preferably, it was 2 pts·mass or greater. Further preferably, it was 3 pts·mass or greater. Preferably, it was 10 pts·mass or less. More preferably, it was 7 pts·mass or less. Further preferably, it was 5 pts·mass or less.

Preferably, the oxide was 2 pts·mass or greater to the SiOx of 100 pts·mass when it is converted to a numerical value of the corresponding Al or Mg. More preferably, it was 3 pts·mass or greater. Further preferably, it was 5 pts·mass or greater. Still further preferably, it was 10 pts·mass or greater. Preferably, it was 20 pts·mass or less. More preferably, it was 18 pts·mass or less. Further preferably, it was 15 pts·mass or less. The oxide is an oxide. Therefore, it is normally regulated by a amount (weight) of oxide. Here, the oxide was not regulated by the amount (weight) of oxide but was converted to “the numerical value of the corresponding Al or Mg”. In a case where the oxide is Al₂O₃, the amount (weight) of the oxide is a value when it is converted to a numerical value of the corresponding Al. In a case where the oxide is MgO, the amount (weight) of the oxide is a value when it is converted to a numerical value of the corresponding Mg. In a case where the oxide is Al₂MgO₄, the amount (weight) of the oxide is a value when it is converted to a numerical value of the corresponding Al₂Mg.

When the amount (weight) of the SiOx became too small, the capacity tended to be small. In a case where the amount (weight) of the SiOx became too large, the resin-made thermolysis product and the Sn tended to be relatively small in amount (weight), and the conductivity tended to be lowered. The cycle characteristic tended to be degraded. In a case where the amount (weight) of the Sn particles became too small, the effect of the present invention was not produced. In a case where the amount (weight) of the Sn particles became too large, the capacity tended to be small. In a case where the amount (weight) of the oxide became too large, the capacity tended to be small.

Preferably, a thickness L1 of the oxide layer 4 (a thickness intervening between the resin-made thermolysis product layer 1 and the SiOx layer 2) was 10 nm or greater. More preferably, it was 20 nm or greater. Further preferably, it was 30 nm or greater. Preferably, it was 1000 nm or less. More preferably, it was 200 nm or less. Further preferably, it was 100 nm or less. In a case where the thickness of the oxide layer was too thin, it was hard to keep the structure thereof. In a case where the thickness of the oxide layer was too thick, it was hard to control the volume change.

With respect to the thickness L2 and L3 (L2, L3<L1) of the oxide region (phase) 5, as known from FIG. 4, a thickness direction of the thickness L2 of the oxide region (phase) 5 has the same direction as the thickness direction of the thickness L1 of the oxide region (phase) 5. A thickness direction of the thickness L3 of the oxide region (phase) 5 has a direction different to the thickness direction of the thickness L1 of the oxide region (phase) 5. In a case where the thickness direction of the oxide region (phase) 5 differs from the thickness direction of the oxide layer 4, the thickness L3 can be also called as a width of the oxide region (phase) 5). The thickness L2 and L3 were preferably 5 nm or greater. More preferably, it was 10 nm or greater. Preferably, it was 100 nm or less. More preferably, it was 50 nm or less. In a case where the thickness of the oxide region (phase) 5 was too thin, it was difficult to control the volume change. In a case where the thickness of the oxide region (phase) 5 was too thick, a moving speed of lithium ion was lowered.

The second invention is directed to a method for producing composite material. The method includes a process of resin-coating a surface of a SiOx (x≤1.2) particle (first process). The method includes a process of mixing the resin-coated SiOx (x≤1.2) particle with Sn particles (second process). The method includes a process of heating the mixture (third process).

Any method may be employed for coating the surface of the SiOx particle by resin. One of examples is a method in which a resin solution (e.g., aqueous solution) and the SiOx are mixed together and, thereafter, the solution is removed by a spray drying method (or, an electrostatic atomization method or a gel solidification method). For the sake of mass-production, the spray drying method is preferred.

Preferably, in the method, one or more selected from the group consisting of Al particles and Mg particles (both metal particles) is further mixed upon mixture. Al—Mg alloy particles are considered as the Al particles or the Mg particles. In a case of alloy, Al/Mg=30/70-70/30 (wt %) was preferred. An alloy of Al/Mg=40/60-50/50 (wt %) was more preferred. The mixture of the Al particles and the Mg particles is also considered as Al particles or Mg particles. There is no specific restriction in purities of the Al and Mg. The purity of 99% or greater was, however, preferred. The purity of 99.5% or greater was more preferred. There was no specific restriction in size of the Al particles and the Mg particles. In a case where the particles are too small or too large, mixture thereof, however, was difficult. Preferably, the Al particles and the Mg particles had a size of 1 μm or greater. More preferably, they had a size of 10 μm or greater. Preferably, they had a size of 200 μm or less. More preferably, they had a size of 50 μm or less. The mixture may be performed by adding all the materials together at the same time or may be performed by adding one by one in series. For example, after the addition of the Sn particles, the Al (or Mg) particles may be added. Alternatively, this order may be reversed. A publicly known method is employed as the mixing method. As a matter of course, any new method may be employed. A wet method and a dry method are exemplified. In view of the mass production, employment of dry method was preferred. As the dry method, a media method and a medialess method are exemplified. Sn is easy to be deformed by a mechanical pressure. Therefore, the medialess method is preferred. More specifically, a container rotating type and a stirring type are exemplified. The container rotating type which works with a low mechanical strength is preferred. Still more specifically, a V-type mixing chamber, a W-type mixing chamber, and a dram-type mixing chamber are exemplified.

The method includes the second process and the third process. This causes the Sn particles move gradually from the surface of the SiOx (x≤1.2) particle toward the inside. The Sn particles (metal particles) are unevenly distributed. A structure having such form could hardly be obtained by the Chemical Vapor Deposition method (see, Patent Literature 3) and the Mechano-milling method. Because the first process is performed before the second process, the oxide layer exists in contact with the resin oxide, and the SiOx particle on the side contacting the oxide layer becomes the SiOy (0≤y<1.2, y<x).

Preferably, the heating temperature in the third process was 500° C. or higher. More preferably, it was 800° C. or higher. Preferably, it was 1200° C. or lower. More preferably, it was 1100° C. or lower. In a case where the temperature was too low, the thermal decomposition was hard to progress. In a case where the temperature was too high, uneven distribution of SiO progressed. The cycle characteristic was degraded. There is no specific limitation in the heating method. A publicly known method such as a gas furnace, an electric furnace, and a high-frequency induction heating furnace can be employed. The electric furnace capable of providing an easy temperature control was preferred. There is no specific limitation in atmosphere upon heating. Here, an inert gas atmosphere was preferred. As the inert gas, N₂, Ar, and He are exemplified.

After the third process, a crushing process, a classification process, etc. are employed, as required.

The above-mentioned method is, for example, the method for producing composite material. Therefore, regarding the characteristics of the blending quantity and the size of the resin, the SiOx, the Sn, the Al, and the Mg, the parts explaining the composite material is invoked. Here, what we were deeply interested in was a fact that there was no inconvenience when the Sn to be added was larger in size than the SiOx. In other words, even if the Sn particles larger than the SiOx were used, the Sn particles in thus obtained composite material were smaller than the SiOx. The inventor assumes that the Sn particles were dissolved to come into the SiOx and were dispersed inside while the Sn and the Si bond together.

What attracts deeply here is the followings. The added Sn, Al, and Mg are metal particles. The Sn particles in the composite material obtained by the above-mentioned producing method were metal particles. The Sn particles existed in the SiOx. The Al and the Mg in the composite material became oxide. The oxide existed on the surface of the SiOx.

The third invention is directed to a negative electrode. The negative electrode is made by using the composite material.

The fourth invention is directed to a secondary battery. The secondary battery includes the negative electrode.

The composite material is used as the member of an electrical element (an electron element is also included in the electrical element). For example, it is used as an active material of a negative electrode for a lithium ion battery. It is used as an active material of a negative electrode for a lithium ion capacitor.

In a case where the composite material of the present invention is used for a lithium ion battery or a lithium ion capacitor, a technical idea disclosed in, for example, a specification of U.S. Pat. No. 6,142,332, a specification of U.S. Pat. No. 6,229,245, a specification of U.S. Pat. No. 6,283,800, and a specification of U.S. Pat. No. 6,283,801 can be invoked. A detailed explanation of the electrode made from the composite material of the present invention is omitted here since the Detailed Description of the specifications of the above-mentioned patents can be invoked.

Hereinafter, more detailed Examples are described. The present invention, however, is not limited only to the below described Examples. In so far as the characteristics of the present invention are not degraded largely, various modifications and application examples are also embraced within the scope of the present invention.

### Example 1

(Producing of Composite Material) A 20% aqueous solution (viscosity of 4% aqueous solution is 3 mPa·s (20° C.)) of PVA (saponification degree of 88 mol %) of 200 g and the SiO particles (average diameter of 5 μm) of 60 g were mixed. The mixture was dried by a spray dryer. A PVA coated SiO particles were obtained. The PVA coated SiO particles and the Sn particles (average diameter of 8 μm; purity of 99.9%) of 1.8 g were mixed. This mixture was baked (under an inert gas atmosphere) at 1000° C. for 3 hours. A composite material was obtained.

### (Producing of Coin Cell)

Mixture was performed such that a mass ratio became: the composite material/acetylene black/carboxymethyl cellulose/styrene butadiene rubber/water=90/6/2/2/200. Kneading and mixing were performed. Coating by a material resulted from the kneading and mixing was provided (solid fixing thickness of 4 mg/cm²) onto a surface of a copper foil. Drying was performed at 100° C. for 5 minutes. Roll pressing (pressure of 1.5 MPa) was performed. A negative electrode was obtained.

The obtained negative electrode, a lithium foil, an electrolytic solution (LiPF6 in EC/DMC/DEC=1:1:1 (v/v/v) 1.0 M), and a separator were used to produce a coin cell.

A discharge and charge device was used. Under conditions of upper limit voltage of 1500 mV, lower limit voltage of 10 mV, charging: CCCV of 0.1 C, and discharging: CV of 0.1 C, the coin cell was charged and discharged once. A charge capacity and a discharge capacity were calculated. The initial charge discharge efficiency was obtained by discharge capacity/charge capacity×100(%). The result is shown by Table-1.

### (Producing of Pouch Cell)

Mixture was performed such that a mass ratio became: the composite material/artificial graphite/carboxymethyl cellulose/styrene butadiene rubber/water=12/86/1/1/180. Kneading and mixing were performed. Coating (solid fixing thickness of 4 mg/cm²) of a material resulted from the kneading and mixing was provided on a surface of a copper foil. Drying was performed at 100° C. for 5 minutes. Roll pressing (pressure of 1.5 MPa) was performed. A negative electrode was obtained.

The obtained negative electrode, a positive electrode made of a Li mixed metal oxide of Mn, Ni, and Co, an electrolytic solution (LiPF6 in EC/DMC/DEC=1:1:1 (v/v/v) 1.0 M), and a separator were used to produce a pouch cell.

A discharge and charge device was used. Under conditions of upper limit voltage of 4200 mV, lower limit voltage of 3000 mV, charging: CCCV of 0.1 C, and discharging: CV of 0.1 C, the pouch cell was charged and discharged for 500 times. A discharge capacity was measured. The capacitance maintenance factor was obtained by discharge capacity at the 500^{th}/discharge capacity at the 1^{st}×100(%). The result is shown by Table-1.

### (Measurement of Carbon Content)

A high-frequency induction heating furnace type carbon-sulfur analysis apparatus was used. A carbon content of the composite material was measured. A composition ratio was obtained by prorating mix proportions of the other ingredients. The result is shown by Table-1.

### (Confirmation of Structures of Tin Particles and Oxide Layer)

A thin film slice of the composite material was produced. It was observed by the STEM (acceleration voltage of 200 kV). With the use of EDX device, mapping was performed for each element.

Upon mapping of Sn, if Sn particles (metal particles: diameter of 1-50 nm) can be observed, it is shown by “Sn particles: presence” in Table-1. For other results, it is shown by “Sn particles: absence” in Table-1.

By the STEM image and the mapping of Si, Al, and Mg, if such a structure (see, FIG. 4) that SiOy (0≤y<1) exists in an oxide layer (thickness of 10-1000 nm, Al₂O₃ (or MgO)) between the PVA thermolysis product and SiO particle can be confirmed, it is shown by “two-phase structure: presence” and, for other results, shown by “two-phase structure: absence”. The result is shown by Table-1.

The composite material of Example 1 had a composition: SiO=84 wt %, C=13 wt %, and Sn=3 wt %.

### Example 21

Everything was performed according to Example 1 except that the weight of Sn particles used in (Producing of Composite Material) of Example 1 was changed from 1.8 g to 0.6 g.

A composite material of Example 2 had a composition: SiO=85 wt %, C=14 wt %, and Sn=1 wt %.

### Example 3

Everything was performed according to Example 1 except that the weight of Sn particles used in (Producing of Composite Material) of Example 1 was changed from 1.8 g to 3 g.

A composite material of Example 3 had a composition: SiO=83 wt %, C=13 wt %, and Sn=4 wt %.

### Example 4

Everything was performed according to Example 1 except that the weight of Sn particles used in (Producing of Composite Material) of Example 1 was changed from 1.8 g to 6 g.

A composite material of Example 4 had a composition: SiO=80 wt %, C=12 wt %, and Sn=8 wt %.

### Example 51

Upon (Producing of Composite Material) in Example 1, in addition to the Sn particles of 1.8 g, Al particles (average diameter of 40 μm; purity of 99.9%) of 1.8 g were mixed, and the others were performed according to Example 1.

A composite material of Example 5 had a composition: SiO=84 wt %, C=12 wt %, Sn=2 wt %, and Al=2 wt %.

The composite material according to the present Example is composed of SiO₁₋ₓ, C, Sn, and AlOx. O of AlOx derives from O of SiO. There is no increase and decrease in O. Therefore, O in the composite material according to the present Example was considered, for the sake of convenience, to be included in SiO. More specifically, naturally, a proportion in AlOx should be shown here, but Al=2 wt % was calculated from the weight of the used Al particles. The same is applied to Examples 6-10.

### Example 61

Upon (Producing of Composite Material) in Example 1, in addition to the Sn particles of 1.8 g, Al particles (average diameter of 40 μm; purity of 99.9%) of 9 g were mixed, and the others were performed according to Example 1.

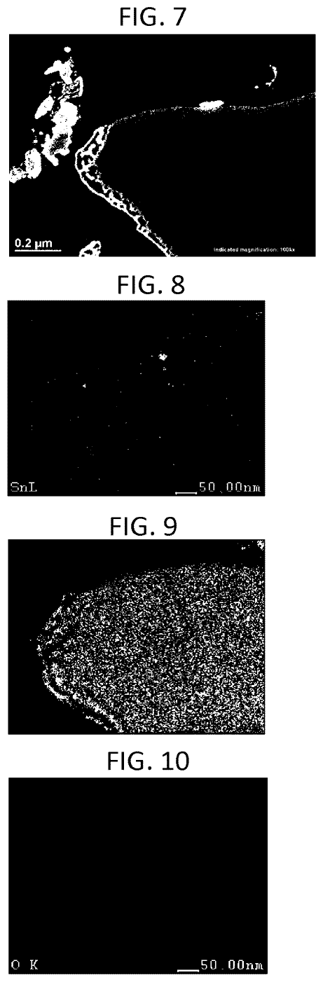

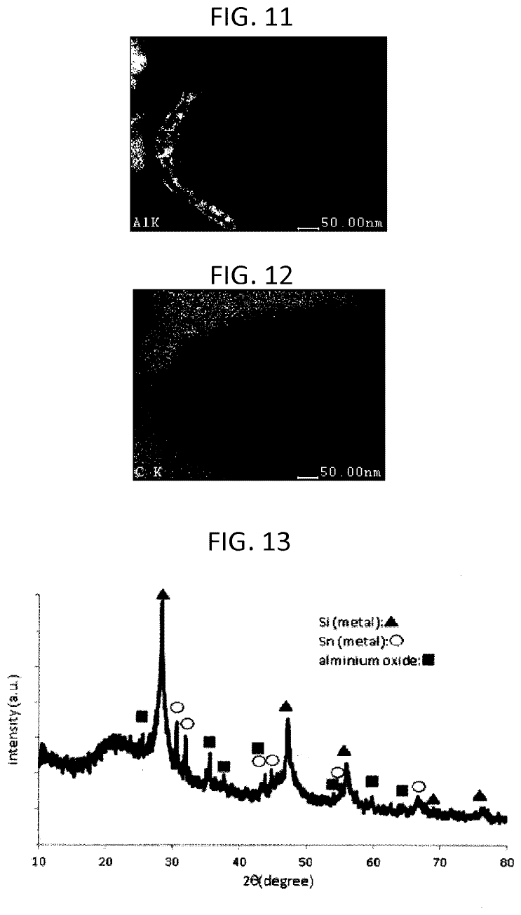

STEM image (annular dark field image (ADF-STEM, 100,000 times (FIG. 5), 800,000 times (FIG. 6)), secondary electron image (SE-STEM) (FIG. 7)), and the mapping images of Sn (FIG. 8), Si (FIG. 9), O (FIG. 10), Al (FIG. 11), and C (FIG. 12) are shown.

Based on the ADF-STEM (100,000 times) and the mapping images of Sn, it was confirmed that Sn particles (metal particles) exist in the composite material of the present Example. Based on the images of the ADF-STEM (800,000 times), it was confirmed that Sn particles each has a diameter of 1-50 nm. In the region where two particles having a diameter of 10 μm or greater were observed, two or more particles having a diameter of less than 10 μm were observed. It was confirmed that Sn particles were unevenly distributed in a surface part of the SiO particle.

It was confirmed from the image of the SE-STEM that the composite material has a Al₂O₃(AlOx) layer having a thickness of 10-1000 nm and the Al₂O₃(AlOx) has a structure of the type as shown in FIG. 4.

Based on the mapping images of Si, 0, Al, and C, it was confirmed that the Al₂O₃ (AlOx) layer existed between the PVA thermolysis product layer and the SiO particle. It was confirmed that y of SiOy in the Al₂O₃ (AlOx) layer was a value less than 1. A thickness of the SiOy was 7-15 nm.

The composite material obtained in the present Example was measured by the XRD. The result is shown by FIG. 13. It was confirmed, when comparing this result with the XRD result disclosed in Non-Patent Literature 1 (FIG. 2), metallic state Sn (metal Sn particles) existed in the composite material of the present Example while no metallic state Sn existed in the composite material of the Non-Patent Literature 1.

A composite material of Example 6 had a composition: SiO=77 wt %, C=10 wt %, Sn=2 wt %, and Al=11 wt %.

### Example 71

Upon (Producing of Composite Material) in Example 1, in addition to the Sn particles of 1.8 g, Al particles (average diameter of 40 μm; purity of 99.9%) of 12 g were mixed, and the others were performed according to Example 1.

A composite material of Example 7 had a composition: SiO=74 wt %, C=9 wt %, Sn=2 wt %, and Al=15 wt %.

### Example 81

Upon (Producing of Composite Material) in Example 1, in addition to the Sn particles of 1.8 g, Mg particles (average diameter of 100 μm; purity of 99.7%) of 1.8 g were mixed, and the others were performed according to Example 1.

A composite material of Example 8 had a composition: SiO=83 wt %, C=11 wt %, Sn=3 wt %, and Mg=3 wt %.

### Example 91

Upon (Producing of Composite Material) in Example 1, in addition to the Sn particles of 1.8 g, Mg particles (average diameter of 100 μm; purity of 99.7%) of 6 g were mixed, and the others were performed according to Example 1.

A composite material of Example 9 had a composition: SiO=79 wt %, C=11 wt %, Sn=2 wt %, and Mg=8 wt %.

### Example 101

Upon (Producing of Composite Material) in Example 1, in addition to the Sn particles of 1.8 g, Mg particles (average diameter of 100 μm; purity of 99.7%) of 12 g were mixed, and the others were performed according to Example 1.

A composite material of Example 10 had a composition: SiO=74 wt %, C=9 wt %, Sn=2 wt %, and Mg=15 wt %.

### Reference Example 11

Upon (Producing of Composite Material) in Example 1, everything was performed according to Example 1 except that the Sn particles were not used.

A composite material of Reference Example 1 had a composition: SiO=91 wt %, C=9 wt %, and Sn=0 wt %.

### Reference Example 21

Upon (Producing of Composite Material) in Example 1, everything was performed according to Example 1 except that the Ti particles (average diameter of 20 μm; purity of 99.9%) of 1.8 g were used instead of the Sn particles.

A composite material of Reference Example 2 had a composition: SiO=84 wt %, C=13 wt %, Sn=0 wt %, and Ti=3 wt %.

### Reference Example 3

Upon (Producing of Composite Material) in Example 1, everything was performed according to Example 1 except that the Zn particles (average diameter of 8 μm; purity of 99.5%) of 1.8 g were used instead of the Sn particles.

A composite material of Reference Example 3 had a composition: SiO=86 wt %, C=13 wt %, Sn=0 wt %, and Zn=1 wt %.

### Reference Example 41

The SiO particles (average diameter of 5 μm) of 60 g was mixed with the Sn particles (average diameter of 8 μm; purity of 99.9%) of 1.8 g. The mixture was baked (under an inert gas atmosphere) at 1000° C. for 3 hours. A composite material was obtained.

A composite material of Reference Example 4 had a composition: SiO=97 wt %, C=0 wt %, and Sn=3 wt %.

Everything was performed according to Example 1 by using the composite material.

### Reference Example 51

Upon (Producing of Composite Material) in Example 6, everything was performed according to Example 6 except that the Sn particles were not used.

A composite material of Reference Example 5 had a composition: SiO=78 wt %, C=10 wt %, Sn=0 wt %, and Al=12 wt %.

TABLE 1

| | | | Capacitance | | |
|---|---|---|---|---|---|
| | Initial | Initial | Maintenance | Sn | Two-phase |
| | Capacity | Efficiency | Factor | Particles | Structure |
| Example 1 | 1610 | 72 | 86 | Presence | Absence |
| Example 2 | 1580 | 72 | 87 | Presence | Absence |
| Example 3 | 1630 | 73 | 85 | Presence | Absence |
| Examplc 4 | 1750 | 73 | 83 | Presence | Absence |
| Example 5 | 1650 | 75 | 88 | Presence | Presence |
| Example 6 | 1680 | 80 | 86 | Presence | Presence |
| Example 7 | 1580 | 83 | 84 | Presence | Presence |
| Example 8 | 1660 | 76 | 90 | Presence | Presence |
| Example 9 | 1710 | 81 | 88 | Presence | Presence |
| Example 10 | 1650 | 85 | 83 | Presence | Presence |
| Reference | 1540 | 70 | 71 | Absence | Absence |
| Example 1 | | | | | |
| Reference | 1320 | 51 | 55 | Absence | Absence |
| Example 2 | | | | | |
| Reference | 1430 | 65 | 60 | Absence | Absence |
| Example 3 | | | | | |
| Reference | 1100 | 63 | 32 | Presence | Absence |
| Example 4 | | | | | |
| Reference | 1520 | 79 | 46 | Absence | Absence |
| Example 5 | | | | | |

Initial Capacity: mAh/g
Initial Efficiency: %
Capacitance Maintenance Factor: %
“Two-phase Structure: Absence” of Reference Example 5 means “A two-phase structure was not clearly observed.”

Table-1 shows the followings. In the composite material of the present invention, both the capacity and the cycle characteristic are improved in comparison with the composite material of the Reference Examples. More specifically, presence or absence of the Sn particles largely influences the capacity and the cycle characteristic. There was no effect produced in using Ti particles and Zn particles instead of the Sn particles. Even in a case where the Sn particles are used, if there is no layer of the resin-made thermolysis product on the surface (Reference Example 4), the effect of the present invention is not produced. In other words, the satisfaction of the following factors was important: the composite material has the resin-made thermolysis product, the SiOx (x≤1.2), and Sn; the surface of the SiOx particle is coated by the resin-made thermolysis product; and the Sn particles exist in the SiOx particle.

In a case of Examples 5-10 in which the oxide (Al₂O₃, MgO, etc.) layer existed between the resin-made thermolysis product and the SiOx, the initial efficiency was high in comparison with the Examples 1-4 in which there was no oxide layer. In the initial efficiency, an increase by only 1% is a large improvement.

### REFERENCE CHARACTER LIST

1 resin-made thermolysis product
2 SiOx particle
3 Sn particles
4 oxide layer
5 oxide continuous phase
6 SiOy independent phase

1: A composite material comprising:
a resin-made thermolysis product,
SiOx particle;
wherein x≤1.2; and
Sn particles,
wherein a surface of the SiOx particle is coated by the resin-made thermolysis product,
wherein the Sn particles exist in the SiOx particle, and
wherein the composite material has substantially no Li.

2: The composite material according to claim 1, further comprising:
at least one oxide selected from the group consisting of an aluminum oxide and a magnesium oxide,
wherein the at least one oxide exists between the resin-made thermolysis product and the SiOx particle.

3: The composite material according to claim 1, wherein a resin of the resin-made thermolysis product is a thermoplastic resin.

4: The composite material according to claim 1, wherein a resin of the resin-made thermolysis product is a polyvinyl alcohol.

5: The composite material according to claim 1, wherein the SiOx particle has an average diameter of 1-20 μm.

6: The composite material according to claim 1, wherein the Sn particles have an average diameter of 1-50 nm.

7: The composite material according to claim 1,
wherein the resin-made thermolysis product is 5-20 pts·mass to the SiOx of 100 pts·mass, and
wherein the Sn particles are 1-10 pts·mass to the SiOx of 100 pts·mass.

8: The composite material according to claim 2, wherein the at least oxide selected from the group consisting of the aluminum oxide and the magnesium oxide is 2-20 pts·mass to the SiOx of 100 pts·mass when it is converted to a numerical value of a corresponding Al or Mg.

9: The composite material according to claim 2,
wherein the at least one oxide forms an oxide layer, and
wherein the composite material further comprises:
SiOy,
wherein 0≤y<1, y<x, and
wherein the SiOy exists in the oxide layer.

10: The composite material according to claim 2,
wherein the at least one oxide forms an oxide layer, and
wherein the oxide layer has a thickness of 10-1000 nm.

11: A negative electrode comprising:
the composite material according to claim 1.

12. (canceled)

13: A method for producing 1 composite material, comprising:
coating a surface of a SiOx particle with a resin to obtain a resin-coated SiOx particle,
wherein x≤1.2;
mixing the resin-coated SiOx particle with Sn particles to obtain a mixture; and
heating the mixture.

14: The method for producing composite material according to claim 13, further comprising:
mixing one or more selected from the group consisting of Al particles and Mg particles with the mixture.

15: The method for producing composite material according to claim 13, wherein the resin is a thermoplastic resin.

16: The method for producing composite material according to claim 13, wherein the composite material resulted from the method comprises a resin-made thermolysis product, SiOx particle, and Sn particles,
wherein x≤1.2,
wherein a surface of the SiOx particle is coated by the resin-made thermolysis product,
wherein the Sn particles exist in the SiOx particle, and
wherein the composite material has substantially no Li.

17: The method for producing composite material according to claim 14,
wherein the composite material resulted from the production method comprises a resin-made thermolysis product, SiOx particle, Sn particles, and at least one oxide selected from the group consisting of aluminum oxide and magnesium oxide,
wherein the surface of the SiOx particle is coated by the resin-made thermolysis product,
wherein the Sn particles exist in the SiOx particle,
wherein at least one oxide selected from the group consisting of the aluminum oxide and the magnesium oxide exists between the resin-made thermolysis product and the SiOx particle, and
wherein the composite material has substantially no Li.
